(19) United States
(12) Patent Application Publication
(10) Pub. No.: US 2026/0066307 A1
(43) Pub. Date: Mar. 5, 2026

(54) ANODE FOR SECONDARY BATTERY, MANUFACTURING METHOD THEREOF, AND LITHIUM SECONDARY BATTERY INCLUDING THE SAME

(71) Applicant: SK ON CO., LTD., Seoul (KR)

(72) Inventor: Won Joon JANG, Daejeon (KR)

(21) Appl. No.: 19/310,934

(22) Filed: Aug. 27, 2025

(30) Foreign Application Priority Data
Sep. 2, 2024 (KR) 10-2024-0118509

(51) Int. Cl. H01M 4/62; H01M 4/02; H01M 4/04; H01M 4/133; H01M 4/1393; H01M 4/587; H01M 10/052

(52) U.S. Cl. CPC H01M 4/626; H01M 4/0404; H01M 4/133; H01M 4/1393; H01M 4/587; H01M 4/622; H01M 10/052; H01M 2004/027

(57) ABSTRACT

An anode for a secondary battery includes an anode current collector, an anode mixture layer disposed on at least one surface of the anode current collector and including an anode active material and an anode binder, and at least one gap that is open on a surface of the anode mixture layer and extends toward the anode current collector. An angle (θ) between the gap and a surface of the anode current collector is 70° to 110°. A method of manufacturing an anode for a secondary battery includes coating by applying an anode slurry containing an anode active material, a binder, and a magnetic material to at least one surface of an anode current collector, recovering the magnetic material contained in the anode slurry using a magnet spaced apart on the anode slurry, and drying the anode slurry and manufacturing an anode mixture layer.

### CROSS-REFERENCE TO RELATED APPLICATION(S)

This patent document claims the priority and benefits of Korean Patent Application No. 10-2024-0118509 filed on Sep. 2, 2024, the disclosure of which is incorporated herein by reference in its entirety.

### TECHNICAL FIELD

The disclosure and implementations disclosed in this patent document generally relate to an anode for a secondary battery and a lithium secondary battery including the same.

### BACKGROUND

Recently, extensive research has been conducted on electric vehicles (EVs) as a potential replacement for fossil fuel-powered vehicles, such as gasoline and diesel powered vehicles, a major source of air pollution. Lithium secondary batteries, with their high discharge voltage and output stability, are primarily used as power sources for such EVs. Consequently, the need for lithium secondary batteries with high energy density and short, rapid charging times is increasing.

However, high energy density and short rapid charging times are inherently trade-offs. As electrode loading increases for high-energy-density secondary batteries, the reduced porosity makes lithium ion diffusion more difficult. This difficulty in lithium ion diffusion increases battery resistance, leading to high overvoltages, reduced battery efficiency, and slow charging speeds.

Therefore, there is a growing need to develop an anode for a secondary battery that possesses both high energy density and excellent rapid charging characteristics.

### SUMMARY

The present disclosure can be implemented in some embodiments to provide an anode for a secondary battery with high energy density and excellent rapid charging characteristics, and a method of manufacturing the same.

The present disclosure may be implemented in some embodiments to provide a lithium secondary battery including the anode for a secondary battery described above.

In some embodiments of the present disclosure, an anode for a secondary battery includes an anode current collector; an anode mixture layer disposed on at least one surface of the anode current collector and including an anode active material and an anode binder; and at least one gap that is open on a surface of the anode mixture layer and extends toward the anode current collector. An angle (θ) between the gap and a surface of the anode current collector is 70° to 110°.

The anode mixture layer may include two or more gaps, and an angle (θ) between each of the gaps may be 0° to 20°.

An upper end diameter of the gap may be 100 nm to 100 μm.

A difference between the upper end diameter and the lower end diameter of the gap may be 0% to 20%.

A ratio of a height of the gap to a thickness of the anode mixture layer may be 1:0.2 to 1:1.

The anode mixture layer may further include a magnetic material.

The magnetic material may be at least one selected from the group consisting of Fe₃O₄, Alnico, Mn—Al—C, Fe—Cr—Co, and Ni—Fe.

The anode active material may include a carbon-based material.

The carbon-based material may have an OI value of 0.4 to 1.0 according to Equation 1 below.

$$OI = {I}_{004} / {I}_{110} \qquad [ Equation 1 ]$$

In Equation 1, OI is an orientation Index measured by XRD, I₀₀₄ is a peak intensity of the (004) plane measured by XRD for the carbon-based material, and I₁₁₀ is a peak intensity of the (110) plane measured by XRD for the carbon-based material.

The anode binder may be an aqueous binder.

The aqueous binder may be at least one selected from the group consisting of styrene-butadiene rubber (SBR) and carboxymethyl cellulose (CMC).

In some embodiments of the present disclosure, a method of manufacturing an anode for a secondary battery includes (a) applying a first anode slurry containing an anode active material, a binder, and a magnetic material to at least one surface of an anode current collector and forming a coating layer; (b) recovering the magnetic material contained in the first anode slurry using a magnet spaced apart on the coating layer; and (c) drying the anode slurry and manufacturing an anode mixture layer.

The (a) applying, the (b) recovering and the (c) drying may be performed by conveying the substrate using a conveying section, and a conveying speed thereof may be 30 m/min to 180 m/min.

The method of manufacturing an anode for a secondary battery may further include, after the (a) applying, applying a second anode slurry containing an anode active material and a binder and not containing a magnetic material, onto the coating layer with the first anode slurry having been applied thereto.

A thickness ratio of the second anode slurry to the first anode slurry may be 1:0.2 to 1:1.

The magnetic material may be at least one selected from the group consisting of Fe₃O₄, Alnico, Mn—Al—C, Fe—Cr—Co, and Ni—Fe.

A strength of the magnet may be 4,000 to 20,000 Gauss.

In some embodiments of the present disclosure, a lithium secondary battery includes the anode for a secondary battery described above.

### BRIEF DESCRIPTION OF DRAWINGS

Certain aspects, features, and advantages of the present disclosure are illustrated by the following detailed description with reference to the accompanying drawings.

FIGS. 1A and 1B are schematic cross-sectional views illustrating the structure of an anode for a secondary battery according to an embodiment.

FIGS. 2A, 2B and 2C are schematic cross-sectional views illustrating the structure of an anode mixture layer according to FIG. 1A.

FIGS. 3A, 3B and 3C are schematic cross-sectional views illustrating the structure of the anode mixture layer according to FIG. 1B.

FIG. 4 is a schematic diagram illustrating a method of manufacturing an anode for a secondary battery according to another embodiment.

FIG. 5 is a schematic diagram illustrating an operation of recovering a magnetic material in a method of manufacturing an anode for a secondary battery according to another embodiment.

### DETAILED DESCRIPTION

Features of the present disclosure disclosed in this patent document are described by example embodiments with reference to the accompanying drawings.

In the present disclosure, when a portion of a layer, film, region, plate, or the like is referred to as being “on” or “over” another part, this includes not only cases where it is “directly over” the other part, but also cases where there is another part therebetween.

### Anode 100 for Secondary Battery

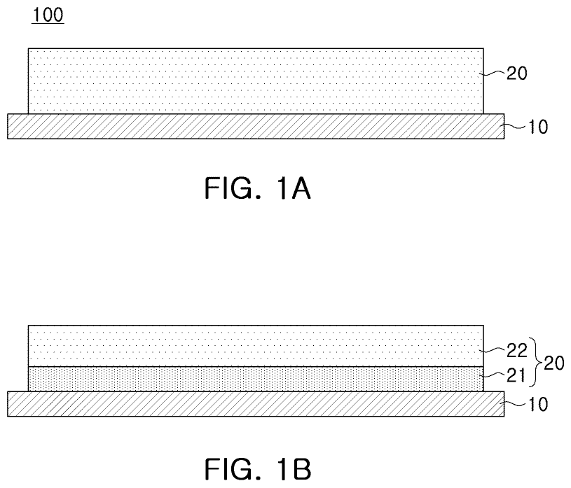

Hereinafter, an anode according to an embodiment of the present disclosure will be described in more detail with reference to the drawings. FIGS. 1A and 1B are schematic cross-sectional views illustrating the structure of an anode 100 for a secondary battery according to an embodiment. As illustrated in FIG. 1A, the anode according to an embodiment may include an anode mixture layer 20 formed on at least one surface of an anode current collector 10.

The anode according to an embodiment may include an anode current collector 10, and an anode mixture layer 20 disposed on at least one surface of the anode current collector 10 and including an anode active material and a binder.

The anode current collector 10 may be selected from the group consisting of copper foil, nickel foil, stainless steel foil, titanium foil, nickel foam, copper foam, a polymer substrate coated with a conductive metal, and combinations thereof, but is not limited thereto. The thickness of the anode current collector 10 is not particularly limited and may range, for example, from 5 to 30 μm.

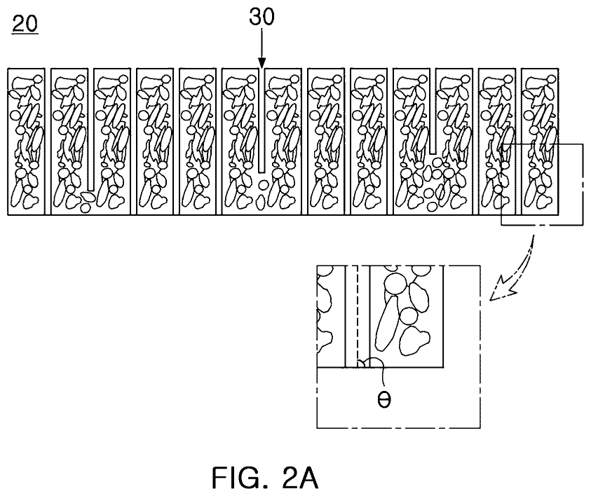

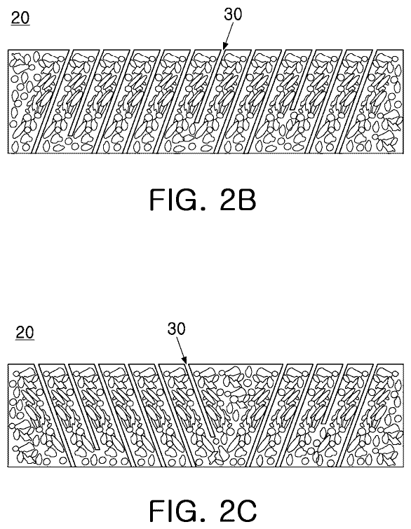

FIGS. 2A, 2B and 2C are schematic cross-sectional views illustrating the structure of the anode mixture layer 20 according to FIG. 1A. An embodiment may include at least one gap 30 open on the surface of the anode mixture layer 20 and extending toward the anode current collector. The gap 30 may serve as a path to facilitate lithium diffusion. This gap enhances the material transport of lithium ions, thereby reducing the resistance of the secondary battery and enhancing rapid charging capability at high energy densities.

The degree of lithium ion diffusion in an anode may be expressed by the tortuosity (τ). This tortuosity may be expressed by the following equation.

τ=ε(D₀/D_{eff})

In this equation, C represents the volume fraction of the gap, and Do and D_{eff} represent the intrinsic lithium ion diffusivity and effective lithium ion diffusivity, respectively. c may be obtained through mercury intrusion analysis and BET analysis, while D_{eff} may be measured using the Restricted-Diffusion Method (RDM).

As the anode loading weight increases, the effective lithium ion diffusivity may decrease. This decrease in effective lithium ion diffusivity may lead to an increase in anode tortuosity, which may lead to increased resistance and reduced efficiency in secondary batteries. In this case, if the gap is included in the anode, the effective lithium ion diffusivity may increase due to a reduced travel distance for lithium ions to diffuse, which may in turn lead to a decrease in tortuosity. Therefore, an anode including the gap may have high energy density and improved rapid charging performance.

An embodiment includes at least one gap 30 that is open toward the surface of the anode mixture layer 20 and extends toward the anode current collector, thereby alleviating distortion caused by a reduced travel distance for lithium ion diffusion. In addition, by improving lithium ion diffusion, the resistance of the secondary battery may be reduced. Furthermore, by exhibiting low overvoltage characteristics, the efficiency of the secondary battery may be improved, and the rapid charging speed may be enhanced.

The gap 30 may extend toward the anode current collector 10. Although not particularly limited, for example, the gap 30 may be a straight pipe shape, a curved pipe shape, or the like, extending in the thickness direction of the anode mixture layer 20. The gap 30 may have equal areas on the upper and lower surfaces, may have a wider area on the upper surface than on the lower surface, or may have a narrower area on the upper surface than on the lower surface.

The gap 30 may be formed, for example, by disposing a magnet on an anode slurry containing a magnetic material and removing the magnetic material with the magnet.

FIG. 2A is a schematic diagram of an anode mixture layer 20 in which the angle (θ) formed between the gap 30 and the surface of the anode current collector 10 is 90°, and FIGS. 2B and 2C are schematic diagrams of an anode mixture layer 20 in which the angle (θ) formed between the gap 30 and the surface of the anode current collector 10 is not 90°. The angle (θ) formed between the gap 30 and the surface of the anode current collector 10 may be 70° to 110°, in detail, 75° to 105°, in more detail, 80° to 100°, and even more specifically 85° to 95°. An anode 100 for a secondary battery including a gap 30 within the above-described angle range may have high energy density due to the elimination of distortion, while also improving rapid charging performance.

In addition, the anode mixture layer 20 may include two or more gaps 30. FIG. 2A and FIG. 2B are schematic diagrams illustrating an anode mixture layer 20 in which the angle (θ) between respective gaps 30 is close to 0°, and FIG. 2C is a schematic diagram illustrating an anode mixture layer 20 in which the angle (θ) between respective gaps 30 is greater than 0°. The angle (θ) between respective gaps 30 may be 0° to 20°, in detail, 0° to 15°, in more detail, 0° to 10°, even more specifically 0° to 5°, and most specifically 0°, and respective gaps 30 may be disposed in parallel, but may not be disposed in parallel. The closer the gaps are to parallel, the easier it is for lithium ions to diffuse into the electrode, thereby improving the charge/discharge efficiency at high energy density and thus improving the rapid charging performance.

The upper end diameter of the gap 30 may range from 100 nm to 100 μm, in detail, from 500 nm to 50 μm, and in more detail, from 1 μm to 10 μm. If the upper end diameter of the gap 30 is less than 100 nm, gap formation may not occur. If it exceeds 100 μm, electrode breakage may occur.

The upper end diameter and the lower end diameter of the gap 30 may be the same or different. In this case, the deviation between the upper end diameter and the lower end diameter of the gap 30 may range from 0% to 70%, in detail, from 0% to 40%.

The ratio of height of the gap 30 to the thickness of the anode mixture layer 20 may range from 1:1 to 1:0.2. If the height of the gap 30 relative to the thickness of the anode mixture layer 20 is less than 0.2, gap formation may be difficult.

The anode mixture layer 20 may include an anode active material and a binder.

The anode active material may include a carbon-based material, such as crystalline carbon, amorphous carbon, a carbon composite, or carbon fiber.

The carbon-based material may be highly or lowly oriented, depending on the an orientation Index measured by XRD.

During battery charging, the carbon-based material primarily expands in the direction of orientation thereof. Highly oriented carbon-based materials tend to have a higher expansion rate, as the expansion is concentrated in a single direction, and thus, the expansion rate of the active material may be relatively high. Conversely, lowly oriented carbon-based materials, which have a low degree of orientation and thus are difficult to orient, tend to have a less biased expansion direction, resulting in a relatively lower expansion rate of the active material.

Accordingly, the lower the orientation Index (OI) of the carbon-based material in the anode, the easier it is for lithium ions to enter and exit, resulting in superior rapid charging characteristics. Furthermore, the orientation direction of the active material is not biased, and numerous sites that may act as buffers during charge/discharge may be present, effectively mitigating expansion of the active material, thereby leading to superior cycle life characteristics.

On the other hand, as the orientation is lower, the hardness of the carbon-based material increases, making it practically difficult to roll low-oriented carbon-based materials at high densities. As a result, it may be difficult to increase the rolling density of anodes containing low-oriented carbon-based materials, limiting the ability to manufacture the anode 100 for secondary batteries with high-energy-density.

Conversely, highly oriented carbon-based materials with relatively high OI values have relatively low hardness, allowing for high-density rolling and contributing to the production of high-energy-density anodes.

In an embodiment, the carbon-based material may have an OI value of 0.4 to 1.0 according to Equation 1 below.

$$OI = {I}_{004} / {I}_{110} \qquad [ Equation 1 ]$$

In Equation 1, OI represents the an orientation Index measured by XRD, I₀₀₄ represents the peak intensity of the (004) plane in the XRD measurement of the carbon-based material, and I₁₁₀ represents the peak intensity of the (110) plane in the XRD measurement of the carbon-based material.

The orientation Index (OI) is the ratio between the peak intensity (I₀₀₄) observed at the (004) plane and the peak intensity (I₁₁₀) observed at the (110) plane in the XRD measurement of the active material, and represents the orientation Index (OI) value. In detail, I₀₀₄ may be the peak intensity value of the (004) plane, which appears at an angle of 2θ=54.7±0.2° when XRD is performed on the active material using CuKα radiation. I₁₁₀ may be the peak intensity value of the (110) plane, which appears at an angle of 2θ=77.5±0.2° when XRD is performed on the active material using CuKα radiation. Generally, peak intensity values refer to peak height values or peak integrated area values, and I₀₀₄ and I₁₁₀ may be calculated using the peak integrated area values.

When the OI value of carbon-based materials falls within the above range, lithium ion transport and diffusion may be enhanced.

Examples of amorphous carbon may include hard carbon, soft carbon, coke, mesocarbon microbeads (MCMB), mesophase pitch-based carbon fiber (MPCF), and the like.

Examples of the crystalline carbon may include graphite-based carbons such as natural graphite, artificial graphite, graphitized coke, graphitized MCMB, and graphitized MPCF.

In addition, the anode active material may further include a material known in the art capable of adsorbing and deintercalating lithium ions, in addition to the carbon-based material. For example, the anode active material may further include lithium metal, lithium alloy, a silicon (Si)-containing material, a tin (Sn)-containing material, or the like.

The lithium metal may be pure lithium metal or lithium metal with a protective layer formed thereon to suppress dendrite growth or the like.

Elements included in the lithium alloy may include aluminum, zinc, bismuth, cadmium, antimony, silicon, lead, tin, gallium, indium, or the like.

The silicon-containing material may include, for example, silicon (Si), silicon oxide (for example, SiOx, 0<x<2), metal-doped silicon oxide, or a silicon-carbon composite compound such as a Si/C composite containing carbon (C) and silicon (Si).

The anode active material may be included in an amount of 60 to 98 wt % based on the total weight of the anode mixture layer 20.

The anode binder may be an aqueous binder or a non-aqueous binder, and in detail, may be an aqueous binder, and in detail, may be a styrene-butadiene rubber (SBR) binder, carboxymethyl cellulose (CMC), or the like. By including an aqueous binder in the anode mixture layer 20, anode swelling may be improved and the adhesion between the current collector and the anode mixture layer 20 may be enhanced. In detail, when using the SBR binder or the like, the binder is mixed into the slurry in a particulate form, and thus, it has practically no effect on increasing the slurry viscosity. Furthermore, the binder is easily dispersed, so there is no problem of forming an insulating region (layer) due to binder agglomeration. Furthermore, the binder has excellent spreadability with the current collector, so it may be uniformly applied in the width direction, thereby improving the adhesion between the current collector and the mixture layer.

The binder may be included in an amount of 0.1 to 5 wt % based on the total weight of the anode mixture layer 20. If the binder content is excessively low, the adhesion of the anode mixture layer 20 adjacent to the current collector may be reduced, which may result in problems such as scrap generation and mixture layer deintercalation during the notching process. On the other hand, if the binder content is excessively high throughout the anode, electrical resistance may increase, which may deteriorate battery characteristics.

The anode mixture layer 20 may further include a magnetic material. The magnetic material may be at least one selected from the group consisting of Fe₃O₄, Alnico, Mn—Al—C, Fe—Cr—Co, Ni—Fe and the like. The anode mixture layer 20 may form a porous electrode by using a magnet by including the magnetic material.

The magnetic material may be present in an amount of 0.1 to 10 wt % based on the total weight of the anode mixture layer 20. If the content of the magnetic material exceeds 10 wt %, the magnetic material may remain in the electrode, reducing energy density.

The anode mixture layer 20 may further include a thickener, a dispersant, a conductive agent, and the like. In an embodiment, the anode mixture layer 20 may include a thickener such as carboxymethyl cellulose (CMC).

The conductive material is used to provide conductivity to the electrode and maintain the structure of the electrode and the like, and may be used as a conductive material that has conductivity but does not cause side reactions with other elements of the secondary battery. For example, the conductive material may include graphite such as natural graphite or artificial graphite; a carbon-based material such as carbon black, acetylene black, Ketjen black, channel black, furnace black, lamp black, thermal black, or carbon fiber; metal powder or metal fiber such as copper, nickel, aluminum, or silver; conductive whiskers such as zinc oxide or potassium titanate; conductive metal oxide such as titanium oxide; or a conductive polymer such as polyphenylene derivatives, and the like, and one thereof may be used alone or a mixture of two or more thereof may be used. In detail, the conductive material may include carbon nanotubes (CNTs). Carbon nanotubes (CNTs) have higher electron mobility than existing conductive materials such as carbon black, enabling high energy density implementation even with a small amount, and in addition, may have high strength due to the stable structure thereof, and may substantially alleviate volume expansion of silicon-based active materials. Therefore, when the conductive material includes carbon nanotubes (CNTs), the energy density, life characteristics, and resistance characteristics of the electrode may be further improved.

An anode 100 for a secondary battery according to an embodiment may have a multilayer structure. The anode 100 for a secondary battery may include anode active materials with different orientations in respective layers in an appropriate distribution, thereby obtaining excellent rapid charging characteristics and energy density.

FIG. 1B is a schematic cross-sectional view illustrating the multilayer structure of an anode 100 for a secondary battery according to an embodiment. As illustrated in FIG. 1B, the anode according to an embodiment may include an anode mixture layer 20 formed on at least one surface of an anode current collector 10. The anode mixture layer 20 may include a first anode mixture layer 21 formed on the anode current collector 10 and a second anode mixture layer 22 formed on the first anode mixture layer 21.

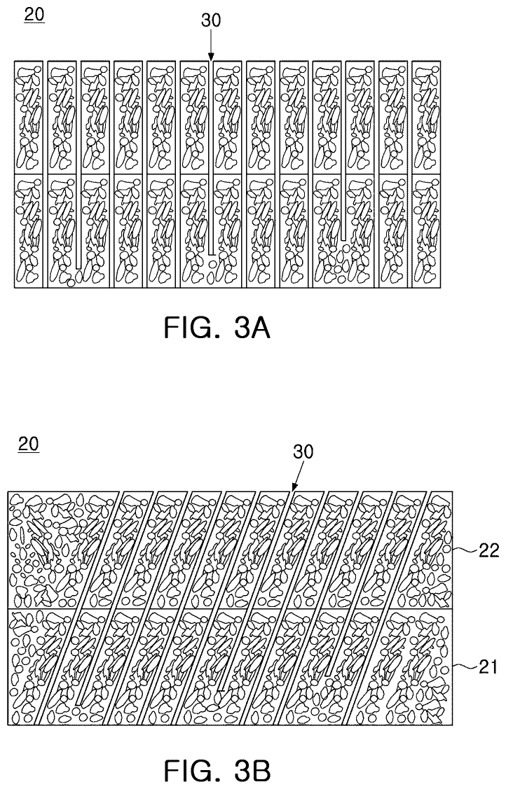

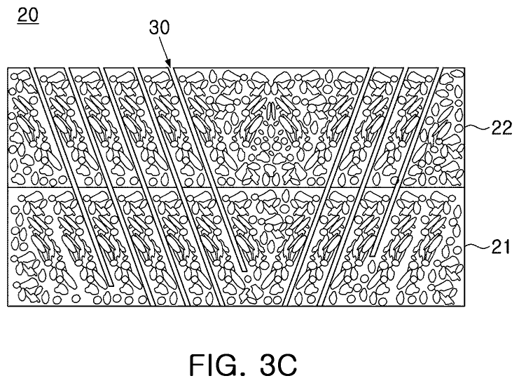

FIGS. 3A, 3B and 3C are schematic cross-sectional views illustrating the structure of the anode mixture layer 20 according to FIG. 1B. Referring to FIGS. 3A, 3B and 3C, the height ratio of the gap 30 to the thickness of the second anode mixture layer 22 may be 1:1, and the height ratio of the gap 30 to the thickness of the first anode mixture layer 21 may be 1:1 to 1:0.2.

FIG. 3A is a schematic diagram of an anode mixture layer 20 in which the angle (θ) formed between the gap 30 and the surface of the anode current collector 10 is 90°, while FIGS. 3B and 3C are schematic diagrams illustrating an anode mixture layer 20 in which the angle (θ) formed between the gap 30 and the surface of the anode current collector 10 is not 90°. The angle (θ) formed between the gap 30 and the surface of the anode current collector 10 may be 70° to 110°, in detail, 75° to 105°, in more detail, 80° to 100°, and even more specifically 85° to 95°. An anode 100 for a secondary battery including a gap 30 within the above angle range may have high energy density and improved rapid charging performance due to distortion being eliminated.

In addition, the anode mixture layer 20 may include at least two or more gaps 30. FIG. 3A and FIG. 3B are schematic diagrams illustrating an anode mixture layer 20 in which the angle (θ) between the respective gaps 30 is close to 0°, and FIG. 3C is a schematic diagram illustrating an anode mixture layer 20 in which the angle (θ) between the respective gaps 30 is greater than 0°. The angle (θ) between respective gaps 30 may range from 0° to 20°, in detail, from 0° to 15°, in more detail, from 0° to 10°, and even more specifically from 0° to 5°, and most specifically, may be 0°. Respective gaps 30 may be disposed parallel or not parallel to each other. The closer the gaps are to being parallel, the easier it is for lithium ions to diffuse into the electrode, thereby improving charge/discharge efficiency at high energy densities and enhancing rapid charging performance.

The first anode mixture layer 21 and the second anode mixture layer 22 may each include an anode active material and a binder. The anode active material and binder may be the same as the anode active material and binder described above. The contents of the anode active material and the contents of the binder contained in the first anode mixture layer 21 and the second anode mixture layer 22 may be the same as or different from each other, respectively.

The first anode mixture layer 21 and the second anode mixture layer 22 may further include a magnetic material. The contents of the magnetic material contained in the first anode mixture layer 21 and the second anode mixture layer 22 may be the same or different.

The first anode mixture layer 21 and the second anode mixture layer 22 may further include a thickener, a dispersant, a conductive agent, and the like. The contents of the thickener, dispersant, conductive agent, and the like contained in the first anode mixture layer 21 and the second anode mixture layer 22 may be the same or different.

According to an embodiment, the anode has an anode active material and a gap 30 within the anode mixture layer 20, in detail, the gap 30 which is oriented perpendicular to the anode current collector 10, thereby facilitating the diffusion of lithium ions into the electrode and thus, improving the charge/discharge efficiency at high energy density and rapid charging performance.

Method of Manufacturing Anode 100 for Secondary Battery

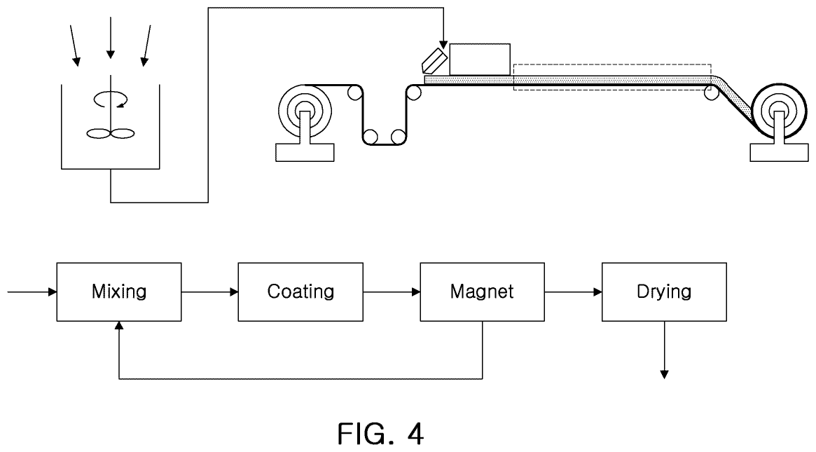

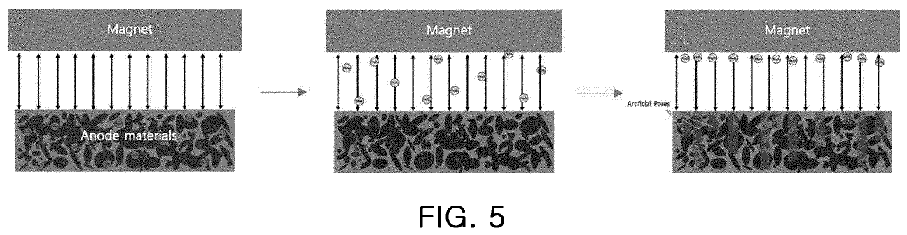

FIG. 4 is a schematic diagram illustrating a method of manufacturing an anode 100 for a secondary battery according to another embodiment. The method of manufacturing an anode 100 for a secondary battery includes: (a) forming a coating layer by applying an anode slurry containing an anode active material, a binder, and a magnetic material onto at least one surface of an anode current collector 10; (b) recovering a magnetic material included in the anode slurry, using a magnet spaced apart on the coating layer; and (c) drying the anode slurry and producing an anode mixture layer 20.

The anode slurry may include an anode active material, a binder, and a magnetic material. The anode active material, the binder, and the magnetic material may each be the same as described above. In addition, the anode slurry may further include a thickener, a dispersant, a conductive agent, a solvent, and the like, and the thickener, dispersant, and conductive agent may be the same as described above.

A mixer may be used to produce the anode slurry. The mixer used to mix the anode slurry is typically used to mix two or more components, and any equipment capable of mixing a small amount of slurry may be used without particular limitation.

The solvent may be an aqueous solvent such as water. The solvent content in the anode slurry is not particularly limited. For example, the solvent content of the total anode slurry may range from 30 to 80 wt %. If the solvent content is less than 30 wt %, a high load may occur during the slurry mixing process, reducing the yield of the mixing process. If the solvent content exceeds 80 wt %, the viscosity may be low, reducing the yield of the coating process.

The method of preparing the anode slurry is not particularly limited. For example, the anode active material and magnetic material may be simultaneously added, followed by the addition of a conductive agent, a thickener, and a solvent. Mixing thereof may be performed at a solids content of 60 to 70%. Subsequently, the thickener may be further added, followed by the addition of a solvent to lower the solids content in further mixing. Then, for example, ultimately, the binder may be added and then mixed, thereby preparing the anode slurry.

Based on the solid content of the anode slurry, the anode active material may be included in an amount of 60 to 98 wt %, the binder may be included in an amount of 0.1 to 5 wt %, and the magnetic material may be included in an amount of 0.1 to 10 wt %. Furthermore, although not particularly limited, based on the solid content of the anode slurry, the thickener may be included in an amount of 0.1 to 5 wt %, the dispersant may be included in an amount of 0.1 to 10 wt %, the conductive material may be included in an amount of 0 to 10 wt %, and the remainder may include a solvent.

Another embodiment may include a conveying operation of conveying the anode current collector 10 by a conveying section. The conveying section is not particularly limited, but may be, for example, a conveyor belt or the like. The conveying speed may be 30 m/min to 180 m/min. The anode current collector 10 may be disposed on the conveying section and, while being conveyed, the coating and/or drying operations may be performed.

The application of the anode slurry onto the anode current collector 10 may be performed using any method commonly used in the art, and is not particularly limited. For example, the application may be performed using a slot die coating method, or alternatively, Meyer bar coating, gravure coating, dip coating, spray coating, or other methods. When using the slot die coating method, the angle (θ) formed between the gap 30 and the surface of the anode current collector 10 may be diagonal rather than vertical. When using the spray coating method, the gap 30 may be oriented in a direction close to vertical with respect to the anode current collector 10.

FIG. 5 is a schematic diagram illustrating an operation of recovering a magnetic material in a method of manufacturing an anode 100 for a secondary battery according to another embodiment. Referring to FIG. 5, in another embodiment, the operation of recovering the magnetic material contained in the anode slurry may include recovering the magnetic material contained in the first anode slurry. The magnetic material contained in the first anode slurry may be recovered using a magnet spaced apart on the coating layer. The magnetic material recovered from the magnet may be recycled and added to the anode slurry. Accordingly, an anode 100 for a secondary battery having the structure illustrated in FIGS. 2A, 2B and 2C may be manufactured.

The magnet may be a permanent magnet or an electromagnet. The strength of the magnet may range from 4,000 to 20,000 Gauss.

The magnet and the coated anode slurry may be separated by a distance of 10 cm to 100 cm.

As the magnetic material is recovered, at least one gap 30 may be formed along the path along which the magnetic material contained in the anode slurry moves. The gap 30 serves as a path for easy lithium diffusion, thereby enhancing the diffusion of lithium ions. The gap 30 may change shape depending on the process in which the magnetic material is recovered, and is not particularly limited thereto, but may have, for example, a straight pipe shape, a curved pipe shape, or the like.

The gap 30 may be formed according to the direction in which the anode current collector 10 and the magnet face each other. For example, the gap 30 may have a shape extending in the thickness direction of the anode mixture layer 20. When the magnetic material is recovered while the anode current collector 10 is stopped, the angle (θ) formed by the gap 30 and the surface of the anode current collector 10 may approach 90°, and when the magnetic material is recovered while the anode current collector 10 is transported on the conveying section, the angle (θ) formed by the gap 30 and the surface of the anode current collector 10 may change.

The angle (θ) formed between the gap 30 and the surface of the anode current collector 10 may range from 70° to 110°, in detail, from 75° to 105°, in more detail, from 80° to 100°, and even more specifically from 85° to 95°. The angle (θ) formed between the gap 30 and the surface of the anode current collector 10 may vary depending on factors such as the weight of the magnetic material, the type of magnetic material, the conveying speed of the conveying section, the strength of the magnet, the distance between the magnet and the anode slurry, or the like.

When the gaps 30 are two or more, the angle (θ) between respective gaps 30 may range from 0° to 20°, in detail, from 0° to 15°, in more detail, from 0° to 10°, even more specifically from 0° to 5°, and most specifically, may be 0°. Respective gaps 30 may or may not be disposed parallel.

The gap 30 may have the same or different upper and lower end diameters. In this case, the difference between the upper and lower end diameters of the gap 30 may range from 0% to 70%, in detail, from 0% to 40%. The gap 30 is formed by the movement of a magnetic material, minimizing the diameter difference between the upper and lower ends, which may be advantageous for lithium ion diffusion.

Additionally, the gap 30 is formed along the movement path of the magnetic material, which significantly reduces damage to particle of the anode active material, resulting in high energy density and rapid charging.

Due to the magnetic field of the magnet spaced apart on the coating layer, the carbon-based material contained in the anode slurry may be oriented in a specific direction. This orientation may be defined by the OI value according to Equation 1, as described above, and this value may be the same as described above.

As the carbon-based material is oriented in a specific direction due to the magnetic field of the magnet, pores may be formed within the anode mixture layer 20. These pores may be distinguished from the gap 30 in an embodiment and may have different diameters, shapes, heights, or the like.

The drying process is intended to remove the solvent contained in the anode mixture layer 20. The drying method is not particularly limited, and common drying methods may be applied. Examples thereof include heat drying, such as hot air drying.

The drying process may be performed, for example, at a temperature ranging from 60 to 180° C., in detail, from 70 to 150° C., for a time of 20 to 300 seconds, for example, from 40 to 240 seconds or from 60 to 200 seconds. Excessive drying temperatures and times may increase the diameter of the gap 30, while insufficient drying temperatures and times may decrease the diameter of the gap 30.

A rolling process may be performed after the drying process, and the thickness and density of the anode mixture layer 20 may be controlled through the rolling process. The rolling process may be performed using methods of the related art such as a roll press method or a flat plate press method, and the anode mixture layer 20 may be manufactured to have a thickness of 20 μm or more, 120 μm or less, for example, 40 μm or more, 100 μm or less, or 60 μm or more, or 80 μm or less per side through the rolling process.

Meanwhile, another embodiment may be appropriately applied to a high-density electrode in which the anode mixture layer 20 has a density of 1.5 g/cm³ or more, and thus, the anode mixture layer 20 may be rolled to 1.5 g/cm³ or more, for example, 1.5 g/cm³ or more and 2.2 g/cm³ or less, or 1.5 g/cm³ or more and 2.0 g/cm³ or less.

Another embodiment may manufacture the anode mixture layer 20 using a multilayer anode slurry. The multilayer anode slurry may include a first anode slurry containing an anode active material, a binder, and a magnetic material; and a second anode slurry disposed on the first anode slurry and containing the anode active material and the binder, but not including the magnetic material.

The magnetic material contained only in the first anode slurry may pass through the second anode slurry and be attached to the magnet. Accordingly, an anode 100 for a secondary battery having a structure similar to that illustrated in FIGS. 3A, 3B and 3C may be manufactured.

The contents and types of the anode active material and binder contained in the first and second anode slurries may be the same or different, respectively. Furthermore, the contents and types of the thickener, dispersant, conductive agent, and solvent contained in the first and second anode slurries may be the same or different.

An anode manufactured by a manufacturing method according to another embodiment may improve rapid charging performance by facilitating the diffusion of lithium ions into the electrode by the anode active material and the gap 30 within the anode mixture layer 20, in detail, by the gap 30 oriented in a direction perpendicular to the anode current collector 10, thereby improving the charge/discharge efficiency at high energy density.

### Lithium Secondary Battery

According to an embodiment, a lithium secondary battery includes an anode 100 for a secondary battery according to any one of the above embodiments, and a cathode.

The cathode may include a lithium-transition metal composite oxide. The cathode may include a cathode current collector, and a cathode mixture layer disposed on at least one surface of the cathode current collector and including a cathode active material.

The cathode current collector may include stainless steel, nickel, aluminum, titanium, or alloy¬ thereof. The cathode current collector may also include stainless steel or aluminum surface-treated with carbon, nickel, titanium, or silver.

The cathode active material may include a compound capable of reversibly intercalating and deintercalating lithium ions.

According to example embodiments, the cathode active material for a lithium secondary battery may include a lithium-nickel metal oxide.

For example, the lithium-nickel metal composite oxide may further include at least one of cobalt (Co) and manganese (Mn). In detail, the cathode active material may include a Ni—Co—Mn (NCM) lithium oxide.

In some embodiments, the cathode active material or the lithium-nickel metal composite oxide may include a layered structure or crystal structure represented by the following chemical formula 1.

LiₓNiₐM_{b}O_{2+z} [Chemical Formula 1]

In Chemical Formula 1, 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 1 represents the bonding relationship within the layered structure or crystal structure of the cathode active material and does not exclude other additional elements. For example, M may include Co and/or Mn, and Co and Mn may serve as the main active element of the cathode active material together with Ni. Chemical Formula 1 is provided to express the bonding relationship of the main active elements and should be understood as encompassing the introduction and substitution of additional elements.

In an embodiment, auxiliary elements may be further included in addition to the main active elements to enhance the chemical stability of the cathode active material or the layered structure/crystal structure. The auxiliary elements may be incorporated into the layered structure/crystal structure to form bonds, and this case should also be understood to be included within the chemical structure range represented by Chemical Formula 1.

The auxiliary elements may include at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may also function as an auxiliary active element, such as Al, that contributes to the capacity/output activity of the cathode active material together with Co or Mn.

For example, the cathode active material or the lithium-nickel metal composite oxide may have a layered structure or crystal structure represented by the following chemical formula 1-1.

LiₓNiₐM1_{b1}M2_{b2}O_{2+z} [Chemical Formula 1-1]

In Chemical Formula 1-1, M1 may include Co, Mn, and/or Al. M2 may include the auxiliary element described above. In Chemical Formula 1-1, 0.9≤x≤1.2, 0.6≤a≤0.99, 0.01≤b1+b2≤0.4, and −0.5≤z≤0.1.

The cathode active material may further include a coating element or doping element. For example, elements substantially identical to or similar to the auxiliary elements described above may be used as coating elements or doping elements. For example, the above-described elements may be used alone or in combination of two or more.

The coating elements or doping elements may be present on the surface of the lithium-nickel metal composite oxide particles, or may penetrate through the surface of the lithium-nickel metal composite oxide particles and be incorporated into the bonding structure represented by Chemical Formula 1 or Chemical Formula 1-1.

The electrode assembly may be housed within a case together with an electrolyte to define a lithium secondary battery. According to example embodiments, a non-aqueous electrolyte may be used as the electrolyte.

The non-aqueous electrolyte contains a lithium salt as an electrolyte and an organic solvent, and the lithium salt may be represented as, for example, Li⁺X⁻, and examples of the anion (X⁻) of the lithium salt may include F⁻, Cl⁻, Br⁻, I⁻, NO₃⁻, N(CN)₂⁻, BF₄⁻, ClO₄, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃, CF₃CO₂⁻, CH₃CO₂⁻, SCN⁻, (CF₃CF₂SO₂)₂N⁻, and the like.

The organic solvent may include an organic compound that has sufficient solubility for the lithium salt and additive and does not exhibit reactivity within the battery. For example, the organic solvent may include at least one of a carbonate solvent, an ester solvent, an ether solvent, a ketone solvent, an alcohol solvent, and an aprotic solvent. Examples of the organic solvents may include propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methylacetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethylsulfoxide, acetonitrile, dimethoxyethane, diethoxyethane, sulfolane, gamma-butyrolactone, propylene sulfite, and the like. These may be used alone or in combination of two or more.

The non-aqueous electrolyte may further include additives. The additives may include, for example, cyclic carbonate compounds, fluorine-substituted carbonate compounds, sultone compounds, cyclic sulfate compounds, cyclic sulfite compounds, phosphate compounds, and borate compounds.

The cyclic carbonate compounds may include vinylene carbonate (VC), vinyl ethylene carbonate (VEC), or the like.

The fluorine-substituted cyclic carbonate compounds may include fluoroethylene carbonate (FEC), or the like.

The sultone compounds may include 1,3-propane sultone, 1,3-propene sultone, 1,4-butane sultone, or the like.

The cyclic sulfate compound may include 1,2-ethylene sulfate, 1,2-propylene sulfate, or the like.

The cyclic sulfite compound may include ethylene sulfite, butylene sulfite, or the like.

The phosphate compound may include lithium difluoro bis-oxalato phosphate, lithium difluoro phosphate, or the like.

The borate compound may include lithium bis(oxalate) borate, or the like.

The separator may include a porous polymer film or a porous nonwoven fabric. The porous polymer film may be composed of a single layer or multiple layers containing a polyolefin-based polymer, such as an ethylene polymer, a propylene polymer, an ethylene/butene copolymer, an ethylene/hexene copolymer, an ethylene/methacrylate copolymer, or the like. The porous nonwoven fabric may include high-melting-point glass fibers or polyethylene terephthalate fibers. However, the separator is not limited thereto and may be a high-heat-resistant separator (for example, a ceramic-coated separator) containing ceramic, depending on an embodiment.

In some embodiments, the area (for example, the contact area with the separator) and/or volume of the anode may be larger than that of the cathode. Accordingly, lithium ions generated from the cathode may smoothly migrate to the anode without precipitation, for example.

Lithium secondary batteries, such as those described above, have excellent rapid charging, life, and resistance characteristics, and may thus be significantly useful as power sources for electric vehicles (EVs).

As set forth above, according to an embodiment, an anode for a secondary battery having high energy density and excellent rapid charging characteristics and a method of manufacturing the same may be provided.

In addition, according to an embodiment, a lithium secondary battery including the anode for a secondary battery described above may be provided.

Only specific examples of implementations of certain embodiments are described. Variations, improvements and enhancements of the disclosed embodiments and other embodiments may be made based on the disclosure of this patent document.

What is claimed is:

1. An anode for a secondary battery, comprising:
an anode current collector;
an anode mixture layer disposed on at least one surface of the anode current collector and including an anode active material and an anode binder; and
at least one gap open on a surface of the anode mixture layer and extending toward the anode current collector,
wherein an angle (θ) between the gap and a surface of the anode current collector is 70° to 110°.

2. The anode for a secondary battery of claim 1, wherein the anode mixture layer includes two or more gaps, and an angle (θ) between each of the gaps is 0° to 20°.

3. The anode for a secondary battery of claim 1, wherein an upper end diameter of the gap is 100 nm to 100 μm.

4. The anode for a secondary battery of claim 1, wherein a difference between the upper end diameter and the lower end diameter of the gap is 0% to 20%.

5. The anode for a secondary battery of claim 1, wherein a ratio of a height of the gap to a thickness of the anode mixture layer is 1:0.2 to 1:1.

6. The anode for a secondary battery of claim 1, wherein the anode mixture layer further includes a magnetic material.

7. The anode for a secondary battery of claim 6, wherein the magnetic material is at least one selected from the group consisting of Fe₃O₄, Alnico, Mn—Al—C, Fe—Cr—Co, and Ni—Fe.

8. The anode for a secondary battery of claim 1, wherein the anode active material includes a carbon-based material.

9. The anode for a secondary battery of claim 8, wherein the carbon-based material has an OI value of 0.4 to 1.0 according to Equation 1, OI=I₀₀₄/I₁₁₀, where OI is an orientation Index measured by XRD, I₀₀₄ is a peak intensity of the (004) plane measured by XRD for the carbon-based material, and I₁₁₀ is a peak intensity of the (110) plane measured by XRD for the carbon-based material.

10. The anode for a secondary battery of claim 1, wherein the anode binder is an aqueous binder.

11. The anode for a secondary battery of claim 10, wherein the aqueous binder is at least one selected from the group consisting of styrene-butadiene rubber (SBR) and carboxymethyl cellulose (CMC).

12. A method of manufacturing an anode for a secondary battery, comprising:
(a) applying a first anode slurry containing an anode active material, a binder, and a magnetic material to at least one surface of an anode current collector and forming a coating layer;
(b) recovering the magnetic material contained in the first anode slurry using a magnet spaced apart on the coating layer; and
(c) drying the anode slurry and manufacturing an anode mixture layer.

13. The method of claim 12, wherein the (a) applying, the (b) recovering and the (c) drying are performed by conveying the substrate using a conveying section, and a conveying speed thereof is 30 m/min to 180 m/min.

14. The method of claim 12, after the (a) applying, further comprising applying a second anode slurry containing an anode active material and a binder and not containing a magnetic material, onto the coating layer with the first anode slurry having been applied thereto.

15. The method of claim 14, wherein a thickness ratio of the second anode slurry to the applied first anode slurry is 1:0.2 to 1:1.

16. The method of claim 12, wherein the magnetic material is at least one selected from the group consisting of Fe₃O₄, Alnico, Mn—Al—C, Fe—Cr—Co, and Ni—Fe.

17. The method of claim 12, wherein a strength of the magnet is 4,000 to 20,000 Gauss.

18. A lithium secondary battery comprising the anode for a secondary battery according to claim 1.
